(19) United States
(12) Patent Application Publication
(10) Pub. No.: US 2001/0018829 A1
(43) Pub. Date: Sep. 6, 2001

(54) Plant structure, especially a cryogenic plant structure, comprising components whose dimensional variations due to temperature changes are synchronized

(75) Inventor: Marc Wagner, St. Maur (FR)

Correspondence Address: YOUNG & THOMPSON, 745 SOUTH 23RD STREET 2ND FLOOR, ARLINGTON, VA, 22202

(73) Assignee: L'Air Liquide, Societe Anonyme

(21) Appl. No.: 09/788,595

(22) Filed: Feb. 21, 2001

(30) Foreign Application Priority Data
Feb. 25, 2000 (FR) 00 02413

(51) Int. Cl. F17C 9/02; F25J 3/00; F25J 5/00

(52) U.S. Cl. 62/54.3; 62/643; 62/905

(57) ABSTRACT

Apparatuses which, in steady-state operation, are at temperatures very different from ambient temperature, are each supported by a base support device, or are secured by a separating support device, and are linked by a pipe device. In order to reduce the mechanical stresses on the pipe device, at least two components of the structure among the support devices and the pipe device are made of different materials having an expansion coefficient and/or a thermal conductivity coefficient which are different so that when the plant goes from inactivity at ambient temperature to steady-state operation the variations in length of the components made of different materials are concomitant. Such structures are usable in air distillation plants.

The invention relates to the structure of industrial plants subjected to large thermal gradients, and especially of cryogenic plants, for example plants called cryogenic air separation or distillation plants.

In such plants, the dimensions of the components vary and there is an appreciable displacement of some with respect to others depending on the temperature changes that occur, especially when the plant is in operation and when it is not in operation; since the apparatuses of such a plant have to be linked together sometimes in a rigid manner, for example by pipe systems, these plants are generally made so as to have a structure which is homogeneous and subjected to homogeneous temperature gradients.

However, it is not always possible to obtain such homogeneity, and this then results in large mechanical stresses on the linking components, stresses which may cause cracks in the pipe systems or even fracture thereof. Furthermore, the variations in the respective positions of the apparatuses may disturb the operation of the plant.

This is particularly the case for plants comprising a column reboiler fitted externally to the column alongside it and supported independently. This is also the case when two vessels placed one on top of the other, being secured and separated by a supporting shell and being linked by a pipe system, cool more rapidly than the supporting shell.

The object of the invention is to remedy these drawbacks and relates for this purpose to a plant structure, especially a cryogenic plant structure, comprising at least two apparatuses each supported by a base support device, or one being secured to the other by a separating support device, and being furthermore linked by at least one linking device attached at two respective points on the two apparatuses, characterized in that at least two of its components among the support devices and the linking device are made, over at least part of their length, of different materials having among the expansion coefficient and the thermal conductivity coefficient at least one coefficient whose respective values are different, so that when the plant goes from inactivity at ambient temperature to steady-state operation with the said apparatuses at a temperature very different from ambient temperature, and vice versa, the variations in length of the said components made of different materials over at least part of their length are concomitant so as substantially to avoid mechanical stresses on the linking device resulting from a relative displacement of the points of attachment of the linking device to the two apparatuses.

Since the mechanical stresses due to the temperature variations are largely avoided, the risks of fracture, especially of pipes, are appreciably reduced and the reliability of the plant is improved.

The invention may furthermore have one or more of the following characteristics:

the two apparatuses are supported individually by base support devices made, over at least part of their length respectively, of materials whose expansion coefficient has different respective values;

the linking device comprises at least one pipe linking the two apparatuses;

the apparatuses are a double air distillation column and a reboiler/condenser, respectively;

the structure includes a base support device comprising at least one part made of aluminium or of an aluminium alloy, and another base support device made of stainless steel;

the structure comprises, in the case of a first apparatus, a base support device consisting of a self-supporting framework for this first apparatus and, in the case of a second apparatus, a base support device including a part made of a material different from that of which the self-supporting framework is made;

the base support device includes a part made of a material different from that of which the self-supporting framework is made, the said part being the upper part of the base support device and supporting the second apparatus;

the structure includes a third apparatus which also goes to a temperature very different from ambient temperature when the plant goes from inactivity to steady-state operation, and this third apparatus is supported by the base support device supporting the second apparatus;

the base support device includes a part made of a material different from that of which the self-supporting framework is made, the said part being the lower part of the base support device and supporting the third apparatus;

the structure includes a third apparatus which also goes to a temperature very different from ambient temperature when the plant goes from inactivity to steady-state operation, and this third apparatus is built into the support;

the apparatuses are secured to each other by a separating support and are linked by at least one linking device comprising at least one pipe;

the separating support and the linking device are made, respectively, of materials of which at least the thermal conductivity coefficient has different respective values;

the apparatuses are a medium-pressure column and a low-pressure column, respectively, these forming a double air distillation column;

one of the apparatuses contains a reboiler/condenser;

the linking device comprises at least one pipe which is at least partially made of stainless steel, and the separating support includes a shell which is at least partially made of copper or of a copper alloy.

Further characteristics and advantages of the invention will become apparent from the following description of embodiments of the invention, which are described by way of non-limiting examples and illustrated by the appended drawings in which:

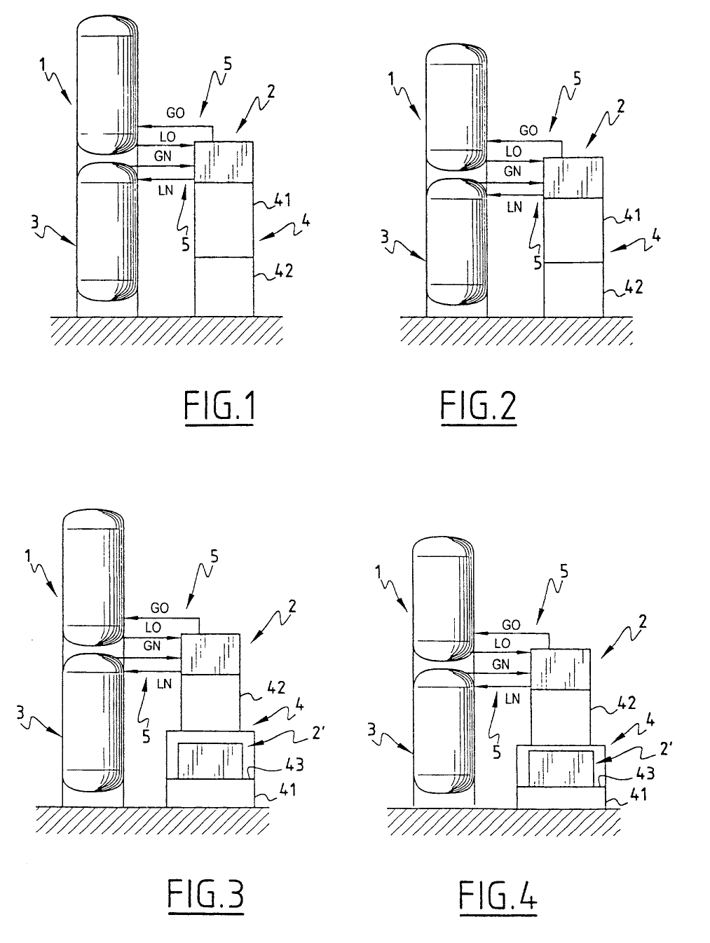

FIG. 1 is a simplified diagram of a first structure according to the invention when the plant is inactive and at ambient temperature;

FIG. 2 is a simplified diagram of this first structure when the plant is in operation with its apparatuses at very low temperature;

FIG. 3 is a simplified diagram of an alternative version of the structure shown in FIG. 1 when the plant is inactive and at ambient temperature;

FIG. 4 is a simplified diagram of the structure shown in FIG. 3 when the plant is in operation with its apparatuses at very low temperature;

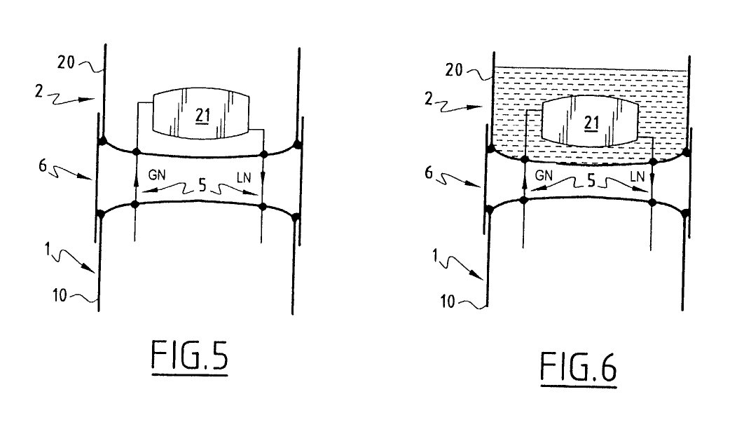

FIG. 5 is a simplified diagram of a second structure according to the invention when the plant is inactive and at ambient temperature; and

FIG. 6 is a simplified diagram of this second structure when the plant is in operation with its apparatuses at very low temperature.

The plant illustrated in FIGS. 1 and 2 comprises two apparatuses 1, 2 which may, for example, if the plant is an air distillation plant, be a double air distillation column and a reboiler/condenser, respectively, these being supported individually.

The double air distillation column has a self-supporting shell or framework 3 resting on the ground and forming the base support device for the double column, or, as a variant, it could be supported by an added base support such as a skirt; in general, the framework of the double column or the skirt is made of austenitic stainless steel; the reboiler/condenser is also placed on a base support 4.

The two apparatuses 1, 2 are linked by one or more linking devices 5 attached at two respective points or regions on these two apparatuses; these linking devices here are, from top to bottom, pipes for transferring gaseous oxygen (GO) from the reboiler/condenser to the double column, liquid oxygen (LO) and gaseous nitrogen (GN) from the double column to the reboiler/condenser and liquid nitrogen (LN) from the reboiler/condenser to the double column, respectively.

When such a plant is not in operation, all its components, comprising the apparatuses 1, 2, the built-in support devices 3 or separate support devices 4, and the linking devices 5, are approximately at ambient temperature and thus the respective points or regions on the two apparatuses where the linking devices are attached are at a distance from one another which is predetermined by construction and for which the linking devices are designed.

When the plant is in operation, the temperature of its apparatuses 1, 2 and more generally of its active components varies, which results in an asynchronous variation in the temperature of the other components depending on the materials of which they are made, on the distance which separates the active components and on the temperature of the nearest active component; this variation, which affects especially the support devices 3, 4 and the linking devices 5, continues after the plant has reached a steady operating state until the temperatures have stabilized approximately; this results in appreciable dimensional changes to most of the components of the plant and unless special precautions are taken, such as those which will be described, the distance between the respective points or regions on the two apparatuses where the linking devices 5 are attached is itself appreciably modified, which runs the risk of damaging these linking-devices.

Thus, in the case of the example described, the double column drops to a very low temperature (about −180° C.) and thus its supporting framework 3, which is relatively tall, and possibly its skirt contract in such a way that the level of its regions for attachment of the linking devices 5 drops significantly.

The drop in temperature of the reboiler/condenser is approximately the same. On the other hand, this reboiler/condenser extends over a relatively small height and is supported by a frame forming a support 4 of relatively great height, for example about twenty meters; if this support 4 is made of stainless steel, which furthermore has a lower thermal conductivity, the drop in level of the regions for attaching the pipes to the reboiler/condenser is less than that of the corresponding region on the double column, and the distance between the two attachment regions is increased. This is why, according to the invention, the reboiler/condenser is placed on a base support 4 at least partially made of a material having characteristics different from those of the material of which the framework 3 forming the base support device for the double column is made, and in this case the base support is, more specifically, made of a material having a higher expansion coefficient. As a result, the smaller drop in temperature of the support 4 compared with the framework of the double column is compensated for by the higher expansion coefficient of at least a part 41 of the height of the support 4 for the reboiler/condenser, preferably here the upper part of the latter, it being impossible for another part 42, here the lower part, to be of the same material as the framework of the double column.

Typically, the outer shells of the double column forming the self-supporting framework of the latter, and possibly its base skirt, are made of stainless steel, the expansion coefficient of which is 13.3×10⁻⁶ m/m.K, and the same applies to part 42 of the support 4 for the reboiler/condenser, whereas the part 41 of the support 4 on which the reboiler/condenser rests is made of aluminium, the expansion coefficient of which is 19×10⁻⁶ m/m.K, or made of an aluminium alloy; the fact that this here is the upper part of the support 4 supporting the reboiler/condenser, which is made of aluminium, a material which has a good thermal conductivity, allows good heat transfer to the lower part made of stainless steel.

More generally:

if the double column has a framework made, for example, of austenitic steel (expansion coefficient αss=13.3×10⁻⁶ m/m.K and thermal conductivity λss=10 W/m.K) and the attachment points for the linking devices 5 are at a height L1 which varies by a value dL1 for a temperature variation DT1 of the double column;

if the support 4 has a total height L2 varying by a value dL2 and its lower part 41 of height Lss is, for example, made of austenitic steel and undergoes a temperature variation DTss whereas its upper part 42 having a height La1 is, for example, made of aluminium (expansion coefficient αa1=19×10⁻⁶ m/m.K and thermal conductivity λa1=160 W/m.K) and undergoes a temperature variation DTa1, then dL1=dL2

if L1.αss.DT1=Lss.αss.DTss+La1.αal.DTa1.

Thus, for a given variation dL1, it is possible, by varying the heights of the parts 41, 42 of the support 4 and the expansion coefficients, to ensure that the levels of the pipe attachment regions remain substantially in the same relative position.

If, for example:

L1=L2=20 meters, Lss=8 meters and La1=12 meters;

final temperature of the column=final temperature of the reboiler/condenser=90 K;

ambient temperature=293 K;

floor-temperature used=283 K;

then dL1=20×13.3×10⁻⁶ (293−90)=0.0540 m=54.0 mm.

Moreover, it is possible to calculate the final temperature at the stainless steel/aluminium interface (T_{interface}) of the support 4 by equating the thermal fluxes of the support 4 (the cross sections being identical):

$$\frac{λ ss}{L ss} ( {T}_{floor} - {T}_{interface} ) = \frac{λ al}{Lal} ( {T}_{interface} - {T}_{reboiler / condensor} )$$

hence it may be deduced that T_{interface}=107 K; as a result, the final average temperature of the steel part is 195 K and the final average temperature of the aluminium part is 98 K.

Therefore we may write:

dL2=8×13.3×10⁻⁶(293˜195)+12×19×10⁻⁶ (293−98);

dL2=0.0104 m+0.0444 m;

dL2=0.0548 m=54.8 mm.

Thus, the difference between the height variations is made negligible.

The alternative embodiment illustrated in FIGS. 3 and 4 corresponds to a plant which includes a third apparatus 2′ whose temperature varies, during operation, in the same sense as that of the first two, and stabilizes approximately to a temperature appreciably different from ambient temperature.

This additional temperature variation may therefore be advantageously used to make the levels of the two first apparatuses 1, 2 equal or to make them closer together.

In the case of the air distillation plant mentioned above, the third apparatus 2′ is a heat exchange line, the operating temperature of which is also appreciably less than ambient temperature, the coldest part of it being about −180° C. This exchange line is used, conventionally, to cool the air to be distilled down to close to its dew point, the air beforehand having been compressed to 5 to 6 bar absolute and purified of water and of CO₂. The air cools therein by indirect heat exchange with the cold gas streams output by the double-column.

As a variant, the apparatus 2 may be another cold exchanger of the plant.

In FIGS. 3 and 4, the components corresponding to the components in FIGS. 1 and 2 are labelled by the same reference numbers; to better take advantage of the drop in temperature of the exchange line 2′, the cold (lower) part of the latter is placed against a platform 43 for the support 4 created in the part 41 of the latter, which is made of a material different from that of the framework of the double column, this part then being the lower part of the support 4; thus, the reboiler/condenser preferably rests on the part 42 of the support 4 which is made of the same material as the framework of the double distillation column, in this case stainless steel.

It is also possible for the apparatus 2′ to be built into the support 4 so that its drop in temperature is communicated to the support 4 in practically all directions.

The plant, part of which is illustrated in FIGS. 5 and 6, comprises two apparatuses 1, 2 shown only partially, one being secured to the other by a separating support device 6. The two apparatuses 1, 2 comprise respective vessels formed by coaxially aligned shells 10, 20, and the separating support 6 which secures them is also a shell or skirt aligned coaxially with the shells 10, 20.

The two apparatuses 1, 2 are linked by the linking devices 5 attached at respective points on these two apparatuses which are internal to the volume bounded by the shell which forms the separating device 6.

In the example illustrated, the plant is a double air distillation column; the upper apparatus 2 is then a low-pressure column which contains a reboiler/condenser 21 from which leave, as linking devices 5, two pipes for linking to the lower apparatus 1, which is a medium-pressure column, into which these pipes 5 penetrate. The purpose of the two pipes is to transfer gaseous nitrogen (GN) from the medium-pressure column to the low-pressure column and liquid nitrogen (LN) from the low-pressure column to the medium-pressure column; they are usually made of stainless steel.

Here again, when the plant is not in operation all its components, comprising the apparatuses 1, 2, the support device 6 and the linking devices 5, are approximately at ambient temperature and the respective points or regions on the two apparatuses where the linking devices are attached, more specifically at the base of the shell 20 of the low-pressure column and at the top of the shell 10 of the medium-pressure column, are at a distance from one another which is predetermined by construction and for which the linking device is designed.

When the plant is in operation, the temperature of the apparatuses 1, 2 varies, and especially in this case the lower part of the low-pressure column gradually fills with liquid at a very low temperature coming from the medium-pressure column (air increasingly enriched with oxygen, and then pure oxygen when the plant reaches its steady operating state); thus, this bottom part rapidly drops in temperature, as does the top part of the column 1, which is filled with gas (air increasingly depleted of oxygen, and then pure nitrogen) at the same temperature; unless special precautions are taken, the thermal paths between the respective points of attachment of the linking devices to the apparatuses do not drop in temperature at the same time; this is because a first path, formed by that part of the pipes 5 which lies between the attachment points is in contact with the two intense cold sources; on the other hand, in the second path, the separating support shell 6 is in contact with the low-pressure column and the medium-pressure column only over a small area, in its two end regions.

According to the invention, in order to compensate for this disparity, the material used for making the separating support shell 6 is a material having a higher thermal conductivity than that of which the linking devices 5 is made. Conventionally, the pipes forming the linking devices 5 are, at least over part of their length and in general their entire length, made of stainless steel which has a relatively poor thermal conductivity (about 10 W/m.K); at least part of the length of the shell 6 or its entire length is then chosen to be made of copper, which has a much greater thermal conductivity (about 400 W/m.K); by way of indication, that of aluminium is about 160 W/m.K) or else of a copper alloy; as a result, when the apparatus starts to drop in temperature, the shell 6 as a whole drops more rapidly in temperature than according to the prior art; on the other hand, since the expansion coefficient of stainless steel is barely less than that of copper (13.3×10⁻⁶ m/m.K and 14×10⁻⁶ m/m.K, respectively), the corresponding final temperatures in the steady state are approximately the same.

Thus, in both examples, the variations in length of the devices made of different materials over at least part of their length (the self-supporting framework forming the base support device 3 for the double column on the one hand and the base support 4 for the reboiler/condenser on the other hand, in the first example and its alternative version; the linking devices 5 on the one hand and the separating support 6 on the other hand, in the second example) are synchronously concomitant so as to substantially avoid mechanical stresses on the linking devices resulting from a relative displacement of the two apparatuses.

Of course, the invention is not limited to the embodiments described and shown above, and it is possible to provide alternative embodiments thereof without departing from its scope, especially plants which at start-up expand rather than contract, such as cryogenic plants, plants making use of combinations of materials other than austenitic stainless steel, aluminium and copper, and/or plants in which the two characteristics of the thermal behaviour, namely the expansion coefficient and the thermal conductivity coefficient, are both varied appreciably.

1. Plant structure, especially a cryogenic plant structure, comprising at least two apparatuses (1, 2) each supported by a base support device (3, 4), or one being secured to the other by a separating support device (6), and being furthermore linked by at least one linking device (5) attached at two respective points on the two apparatuses, characterized in that at least two of its components among the support devices (3, 4; 6) and the linking device (5) are made, over at least part of their length, of different materials having among the expansion coefficient and the thermal conductivity coefficient at least one coefficient whose respective values are different, so that when the plant goes from inactivity at ambient temperature to steady-state operation with the said apparatuses at a temperature very different from ambient temperature, and vice versa, the variations in length of the said components (3, 4; 6, 5) made of different materials over at least part of their length are concomitant so as substantially to avoid mechanical stresses on the linking device (5) resulting from a relative displacement of the points of attachment of the linking device to the two apparatuses (1, 2).

2. Plant structure according to claim 1, characterized in that the two apparatuses (1, 2) are supported individually by base support devices (3, 4) made, over at least part of their length respectively, of materials whose expansion coefficient has different respective values.

3. Plant structure according to claim 1, characterized in that the linking device (5) comprises at least one pipe linking the two apparatuses (1, 2).

4. Plant structure according to claim 1, characterized in that the apparatuses (1, 2) are a double air distillation column and a reboiler/condenser, respectively.

5. Plant structure according to claim 1, characterized in that it includes a base support device (4) comprising at least one part (41) made of aluminium or of an aluminium alloy and another base support device (3) made of stainless steel.

6. Plant structure according to claim 1, characterized in that it comprises, in the case of a first apparatus (1), a base support device (3) consisting of a self-supporting framework for this first apparatus and, in the case of a second apparatus (2), a base support device (4) including a part (41) made of a material different from that of which the self-supporting framework is made.

7. Plant structure according to claim 6, characterized in that the base support device (4) includes a part (41) made of a material different from that of which the self-supporting framework is made, the said part (41) being the upper part of the base support device and supporting the second apparatus (2).

8. Plant structure according to claim 1, characterized in that it includes a third apparatus (2′) which also goes to a temperature very different from ambient temperature when the plant goes from inactivity to steady-state operation, and this third apparatus (2′) is supported by the base support device (4) supporting the second apparatus (2).

9. Plant structure according to claim 8, characterized in that the base support device (4) includes a part (41) made of a material different from that of which the self-supporting framework is made, the said part (41) being the lower part of the base support device and supporting the third apparatus (2′).

10. Plant structure according to claim 1, characterized in that it includes a third apparatus (2′) which also goes to a temperature very different from ambient temperature when the plant goes from inactivity to steady-state operation, and this third apparatus (2′) is built into the support (4).

11. Plant structure according to claim 1, characterized in that the apparatuses (1, 2) are secured to each other by a separating support (6) and are linked by at least one linking device (5) comprising at least one pipe.

12. Plant structure according to claim 11, characterized in that the separating support (6) and the linking device (5) are made, respectively, of materials of which at least the thermal conductivity coefficient has different respective values.

13. Plant structure according to claim 1, characterized in that the apparatuses (1, 2) are a medium-pressure column and a low-pressure column, respectively, these forming a double air distillation column.

14. Plant structure according to claim 1, characterized in that one of the apparatuses (2) contains a reboiler/condenser (21).

15. Plant structure according to claim 1, characterized in that the linking device (5) comprises at least one pipe which is at least partially made of stainless steel and the separating support (6) includes a shell which is at least partially made of copper or of a copper alloy.
